(19) United States
(12) Patent Application Publication
(10) Pub. No.: US 2007/0294487 A1
(43) Pub. Date: Dec. 20, 2007

(54) Unified memory system

(76) Inventors: Yoshiteru Mino, Osaka (JP); Keizo Sumida, Osaka (JP)

Correspondence Address: MCDERMOTT WILL & EMERY LLP, 600 13TH STREET, NW, WASHINGTON, DC, 20005-3096, US

(21) Appl. No.: 11/808,953

(22) Filed: Jun. 14, 2007

(30) Foreign Application Priority Data
Jun. 14, 2006 (JP) 2006-164623

(51) Int. Cl. G06F 13/00

(52) U.S. Cl. 711/147; 711/158

(57) ABSTRACT

The unified memory system includes: a memory accessed from a plurality of masters; a speculative access control section for issuing, in response to a first access request to the memory from a CPU as one of the plurality of masters, a speculative second access request to the memory; and a memory controller for receiving the first and second access requests and an access request to the memory from any of the plurality of masters other than the CPU and executing access to the memory. The speculative access control section issues the second access request according to speculative access information as information related to access to the memory.

### CROSS-REFERENCE TO RELATED APPLICATIONS

This application claims priority under 35 U.S.C. §119 on Patent Application No. 2006-164623 filed in Japan on Jun. 14, 2006, the entire contents of which are hereby incorporated by reference.

### BACKGROUND OF THE INVENTION

The present invention relates to a unified memory system having a memory accessed by a plurality of masters, and more particularly to a technology of controlling speculative access to the memory.

In recent years, equipment ranging from portable products such as cellular phones to stationary products such as digital TVs and digital versatile disc (DVD) recorders uses a plurality of central processing units (CPUs) and digital signal processors (DSPs) for attainment of multi-functional implementation and improved performance. Along with improvement in semiconductor packing density, CPUs and DSPs are integrated on one chip, and a unified memory system, in which a plurality of external memories respectively having meant for exclusive use by CPUs and/or DSPs are shared, has been increasingly adopted, for the purpose of cost reduction.

In such a unified memory system, CPUs and DSPs each operating as a master must wait to use an external memory when another master is using the external memory. If the wait time goes beyond an assumption, this system will no more work as a system. In view of this, some measures, such as that the memory access amounts are allocated to the masters and that the masters are provided with priorities and a higher priority is given to processing of a master higher in priority, are taken to avoid occurrence of a wait time beyond an assumption.

In particular, in a unified memory system handling media processing, burst access has become the mainstream in access to a memory. This is because DSPs, taking charge of media processing, perform media processing in chunks of data.

CPUs have improved their processing performance year by year because they must execute congested processing items such as operation scheduling to DSPs, input/output-related interrupt processing and CPU application processing (e.g., processing for graphical user interface (GUI)).

In a unified memory system, however, a CPU has found difficulty in improving the processing performance for the following reason. Access to a memory is generally made by burst transfer to comply with media processing by DSPs, and thus the latency performance of the memory is not high. Since the CPU mostly processes data of a single input/output unit in a memory, the CPU performance deteriorates as the latency count of the memory increases.

To overcome the above problem, there is known a technology in which a bridge having a buffer memory is placed between a CPU and a memory controller or a buffer memory is provided in a memory controller. In such a technology, burst access is made to a memory irrespective of the request size from a CPU, and read data is held in a buffer memory. Thereafter, once access to data held in the buffer memory is made from the CPU, the data held in the buffer memory is transferred to the CPU. In this way, the apparent latency count of access to the memory from the CPU can be reduced. Moreover, future access to be made by the CPU is predicted, to issue a request of predicted access (speculative access) in addition to an access request from the CPU.

If the prediction hits, the CPU performance can be improved with the speculative access. However, other masters sharing the memory may have to wait to access the memory until the speculative access is terminated. The speculative access may therefore be a factor deteriorating the performance of the other masters.

If the prediction fails, the speculative access is useless, but no access to the memory will be available until termination of such a useless speculative access. The speculative access may therefore increase the latency count of a normal access to follow and be a factor deteriorating the performance of the entire system.

Japanese Laid-Open Patent Publication No. 2003-186669 discloses an example of technology for preventing a speculative access-permitted unified memory system from deteriorating in its system performance due to increase in the access latency of masters caused by speculative access. In this technology, a higher-level master (CPU) in a memory hierarchy clarifies that speculative access is to be made in a data transfer instruction to a lower-level slave (memory controller) in the memory hierarchy. The lower-level slave may discard the speculative access if judging that the system performance may deteriorate by executing the speculative access.

To cancel or discard speculative access, it is necessary to newly design and implement a protocol for enabling the CPU (or bridge) as the access request side and the memory controller as the access reception side to cancel or discard a speculative access request and a corresponding circuit.

However, cancellation of a speculative access request to the memory controller by the CPU (or bridge) occurs at timing independent of the internal state of the memory controller. It is therefore difficult to design and verify the memory controller. Likewise, discard of a speculative access request by the memory controller occurs at timing independent of the internal state of the CPU (or bridge). It is therefore difficult to design and verify the CPU (or bridge). This also applies to the case of providing a buffer memory in the memory controller.

Moreover, if the memory controller has already started memory access in response to a speculative access request, the memory access cannot be stopped normally according to a protocol between the memory controller and the memory. The speculative access must be completed in this case. Thus, the system performance will deteriorate if an unnecessary speculative access request is issued.

### SUMMARY OF THE INVENTION

An object of the present invention is providing a unified memory system in which issuance of a speculative access request is controlled to improve the performance thereof.

The unified memory system according to the present invention includes: a memory accessed from a plurality of masters; a speculative access control section for issuing, in response to a first access request to the memory from a CPU as one of the plurality of masters, a speculative second access request to the memory; and a memory controller for receiving the first and second access requests and an access request to the memory from any of the plurality of masters other than the CPU and executing access to the memory. The speculative access control section issues the second access request according to speculative access information as information related to access to the memory.

With the above configuration, in which a speculative access request is issued according to speculative access information, access to the memory from a master other than the CPU and normal access to the memory from the CPU will be less required to wait due to speculative access. Also, the performance of the unified memory system can be prevented from deteriorating even in the case of increase in access from masters other than the CPU.

According to the present invention, since memory access from a master other than the CPU is less required to wait due to speculative access, the processing performance of a master other than the CPU can be prevented from deteriorating. Also, since normal access from the CPU is less required to wait due to speculative access, the processing performance of the CPU can be improved. In this way, the performance of the unified memory system can be improved. In particular, the present invention is greatly effective when the memory access latency is long.

### BRIEF DESCRIPTION OF THE DRAWINGS

FIG. 1 is a block diagram showing an exemplary configuration of a unified memory system of an embodiment of the present invention.

FIG. 2 is a block diagram showing an exemplary configuration of a bridge in FIG. 1.

FIG. 3 is a block diagram showing an exemplary configuration of a memory controller in FIG. 1.

FIG. 4 is a flowchart showing an example of flow of processing by a CPU in FIG. 1.

FIG. 5 is a flowchart showing another example of flow of processing by the CPU in FIG. 1.

FIG. 6 is a flowchart showing an example of flow of processing by a CPU access control section in FIG. 2.

FIG. 7 is a flowchart showing an example of flow of processing by a speculative access control section in FIG. 2.

FIG. 8 is a timing chart showing a first example of operation of the unified memory system of FIG. 1.

FIG. 9 is a timing chart showing a second example of operation of the unified memory system of FIG. 1.

FIG. 10 is a timing chart showing a third example of operation of the unified memory system of FIG. 1.

FIG. 11 is a timing chart showing a fourth example of operation of the unified memory system of FIG. 1.

FIG. 12 is a timing chart showing a fifth example of operation of the unified memory system of FIG. 1.

### DESCRIPTION OF THE PREFERRED EMBODIMENTS

Hereinafter, a preferred embodiment of the present invention will be described with reference to the accompanying drawings.

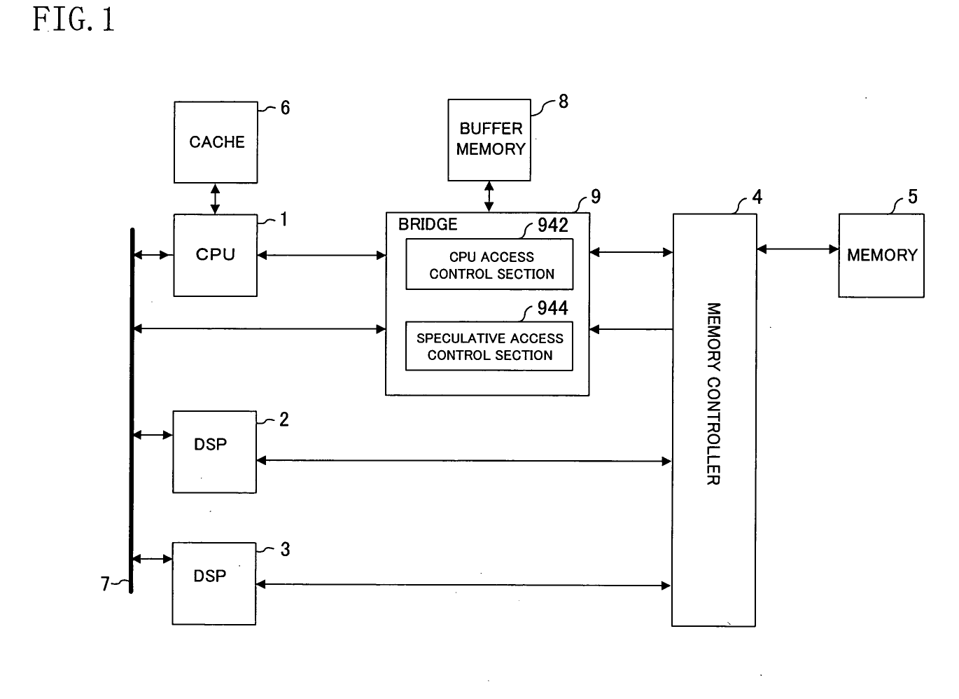

FIG. 1 is a block diagram showing an exemplary configuration of a unified memory system of an embodiment of the present invention. The unified memory system of FIG. 1 includes a memory controller 4, a memory 5, a buffer memory 8 and a bridge 9. The unified memory system is accessed by a CPU 1 and DSPs 2 and 3 each operating as a master. The CPU 1, the DSPs 2 and 3 and the bridge 9 are connected with one another via a CPU control bus 7. A cache 6 is connected to the CPU 1.

The DSPs 2 and 3 perform individual media processing while accessing data in the memory 5 via the memory controller 4. The CPU 1 accesses data in the memory 5 via the bridge 9 and the memory controller 4.

The bridge 9 includes a CPU access control section 942 and a speculative access control section 944. The CPU access control section 942 receives a request of normal access to the memory 5 from the CPU 1 and outputs the request to the memory controller 4. The speculative access control section 944 predicts new access to the memory 5 from the CPU 1 that may follow the requested normal access, based on this normal access from the CPU 1, to thereby issue a speculative access request, and outputs the speculative access request to the memory controller 4.

The memory controller 4, receiving access requests from the bridge 9 and the DSPs 2 and 3, arbitrates the received access requests and accesses the memory 5 according to the arbitration result.

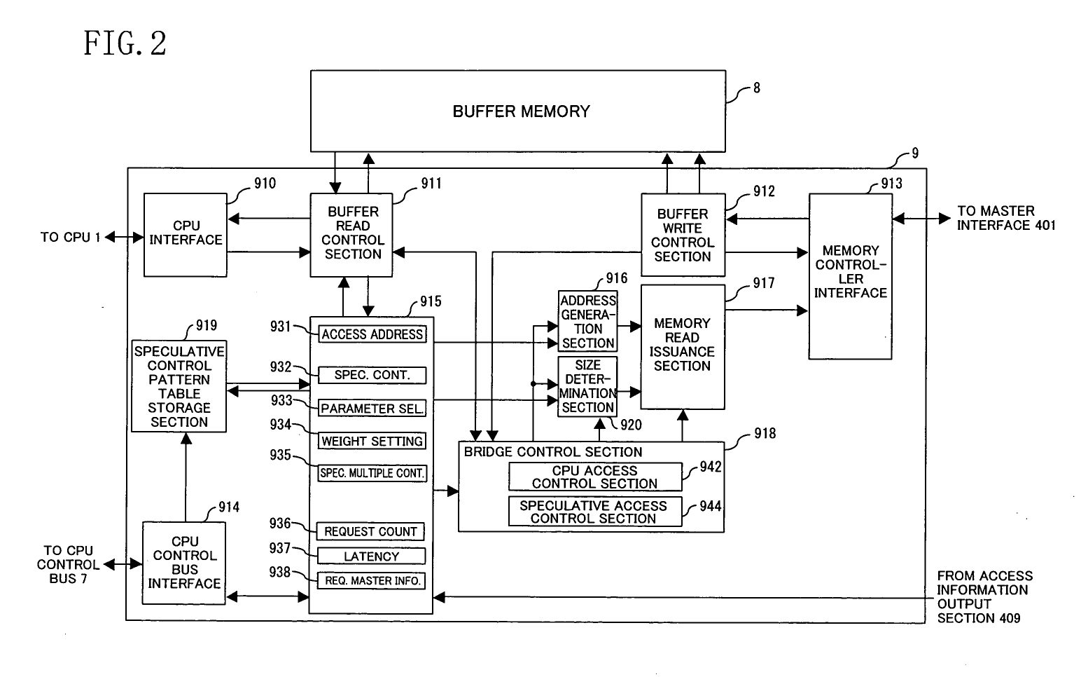

FIG. 2 is a block diagram showing an exemplary configuration of the bridge 9 in FIG. 1. The bridge 9 of FIG. 2 includes a CPU interface 910, a buffer read control section 911, a buffer write control section 912, a memory controller interface 913, a CPU control bus interface 914, a register block 915, an address generation section 916, a memory read issuance section 917, a bridge control section 918, a speculative control pattern table storage section 919 and a size determination section 920.

The register block 915 includes an access address register 931, a speculative control register 932, a parameter selection register 933, a weight setting register 934, a speculative multiple control register 935, a request count register 936, a latency register 937 and a requesting master information register 938.

The bridge control section 918 includes the CPU access control section 942 and the speculative access control section 944. The CPU access control section 942 and the speculative access control section 944 bring the components of the bridge 9 into cooperative operation among them. This cooperative operation will be detailed later.

The access address register 931 holds address information given from the buffer read control section 911 in an address field, and also holds a valid bit indicating whether or not the address information is valid.

The speculative control register 932, which is set by the CPU 1, is a register used to permit the speculative access control section 944 to issue a speculative access request.

The parameter selection register 933, which is set by the CPU 1, is a register for setting a combination of registers used by the speculative access control section 944 in speculative access control.

The weight setting register 934, which is set by the CPU 1, is a register for setting weights for speculative control parameters when a plurality of speculative control parameters are used in speculative access control.

The speculative multiple control register 935, which is set by the CPU 1, is a register used to permit the speculative access control section 944 to issue multiple speculative access requests.

The request count register 936 is a register for storing the number of masters that are under access request, which is speculative access information outputted from the memory controller 4 to the bridge 9. The latency register 937 is a register for storing the latency count (number of cycles required to complete an access to the memory 5) as speculative access information outputted from the memory controller 4 to the bridge 9. The requesting master information register 938 is a register for storing information of a master under access request as speculative access information outputted from the memory controller 4 to the bridge 9. The request count register 936, the latency register 937 and the requesting master information register 938 are all set by the CPU 1 and used to set a condition for issuance of a speculative access request.

The CPU interface 910 outputs access information including a read request from the CPU 1 to the buffer read control section 911, and also outputs read data outputted from the buffer read control section 911 to the CPU 1.

The buffer read control section 911 compares a read address requested by the CPU 1 outputted from the CPU interface 910 with an address held in the access address register 931, and activates the CPU access control section 942 if the two addresses do not agree with each other. If the two addresses agree with each other, the buffer read control section 911 reads data corresponding to the read address from the buffer memory 8, and outputs the data to the CPU interface 910.

If the valid bit in the access address register 931 is invalid, the buffer read control section 911 activates the CPU access control section 942 without performing the address comparison described above.

The buffer write control section 912 writes data outputted from the memory controller interface 913 into the buffer memory 8, and notifies the CPU access control section 942 or the speculative access control section 944 of completion of the write into the buffer memory 8.

The memory controller interface 913 transfers a read access request from the memory read issuance section 917 to the memory controller 4, and outputs read data returned from the memory controller 4 to the buffer write control section 912.

The CPU control bus interface 914 transfers an access from the CPU 1 via the CPU control bus 7, provided for control of the DSPs 2 and 3 and the bridge 9 by the CPU 1, to an accessible register in the register block 915 and the speculative control pattern table storage section 919.

The address generation section 916 generates address information to be attached to a read request issued by the memory read issuance section 917 using the output of the access address register 931.

The memory read issuance section 917 issues a read access request to the memory controller interface 913 under control of the CPU access control section 942 or the speculative access control section 944.

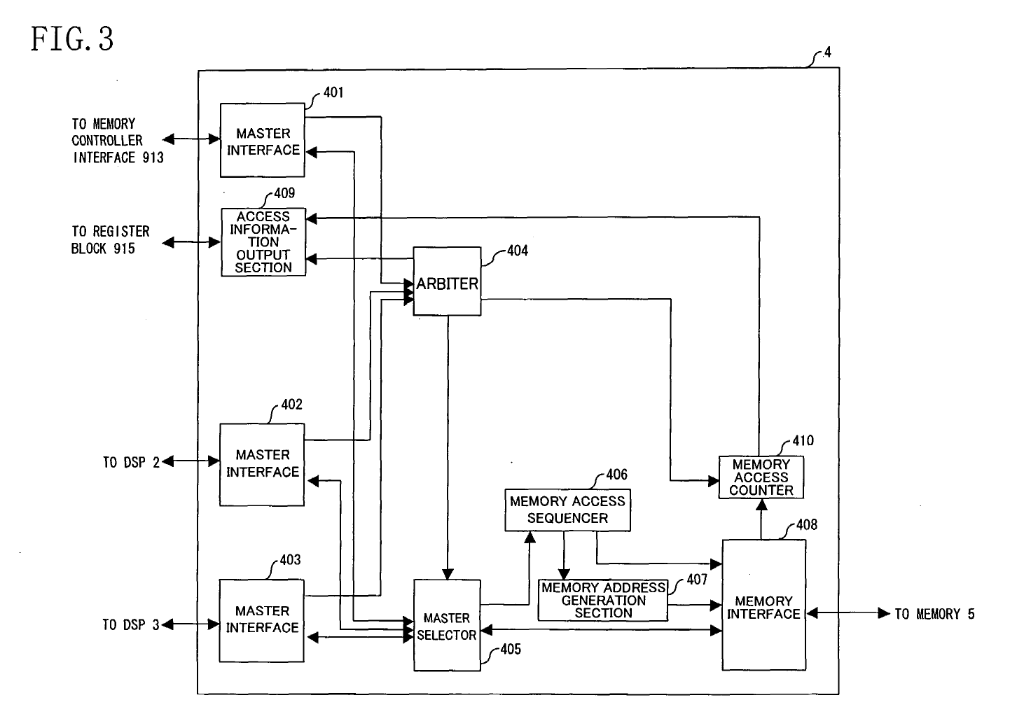

FIG. 3 is a block diagram showing an exemplary configuration of the memory controller 4 in FIG. 1. The memory controller 4 of FIG. 3 includes master interfaces 401, 402 and 403, an arbiter 404, a master selector 405, a memory access sequencer 406, a memory address generation section 407, a memory interface 408, an access information output section 409 and a memory access counter 410.

The master interface 401 controls transfer of an access request from the bridge 9 to the memory controller 4. The master interface 402 controls transfer of an access request from the DPS 2 to the memory controller 4. The master interface 403 controls transfer of an access request from the DPS 3 to the memory controller 4.

The arbiter 404 arbitrates transfer requests from the master interfaces 401 to 403 and notifies the master selector 405 of the arbitration result. Also, the arbiter 404 outputs the number of pre-arbitrated transfer requests to the memory access counter 410.

The master selector 405 selects one of the transfer requests from the master interfaces 401 to 403 according to the arbitration result from the arbiter 404, issues a request for start of memory access corresponding to the selected transfer request to the memory access sequencer 406, and further executes data transfer between the memory interface 408 and the master interface that has outputted the selected transfer request.

The memory access sequencer 406 executes an access sequence predetermined depending on the memory in response to the request for start of memory access.

The memory address generation section 407 generates a memory address under control of the memory access sequencer 406.

The memory interface 408 controls input/output of data from/to the memory 5. Also, during accessing the memory 5, the memory interface 408 outputs the remaining number of cycles until access completion to the memory access counter 410.

The memory access counter 410 receives the remaining number of access cycles from the memory interface 408 and the number of pre-arbitrated transfer requests from the arbiter 404, calculates the number of memory access cycles based on the received numbers, and outputs the calculated result to the access information output section 409.

The access information output section 409 receives the number of access requests under arbitration from the arbiter 404 and outputs the received number to the bridge 9 as the request count. Also, the access information output section 409 receives information indicating masters under arbitration by the arbiter 404 and the number of memory access cycles from the memory access counter 410, and outputs the information and the number to the bridge 9 as the requesting master information and the latency count, respectively. The request count, the requesting master information and the latency count are all speculative access information.

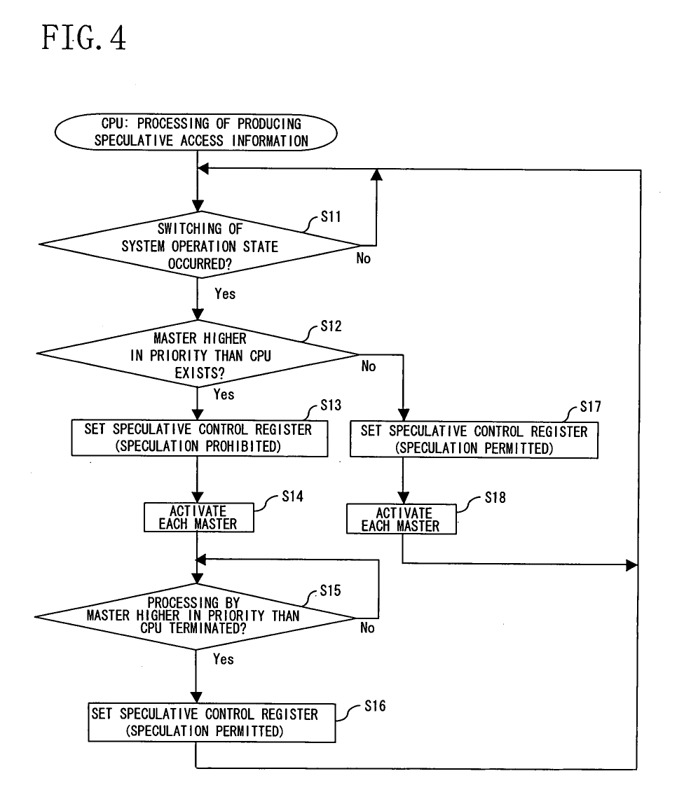

FIG. 4 is a flowchart showing an exemplary flow of processing by the CPU 1 in FIG. 1. In FIG. 4, the CPU 1 detects processing by a master higher than the CPU 1 in memory access priority as speculative access information under CPU software processing, and based on the detected result, controls issuance of a speculative access request by the bridge 9. Assume that the CPU 1 is lower in priority than the DSPs 2 and 3. Assume also that there are system operation state A in which the CPU 1 is the only master that is operating, system operation state B following the system operation state A in which the CPU 1 and the DSPs 2 and 3 are operating, and system operation state C following the system operation state B in which the CPU 1 is the only master that is operating.

In step S11, the CPU 1 detects whether or not switching of the system operation state has occurred. If the occurrence is detected, the process proceeds to step S12, or otherwise returns to step S11.

In step S12, the CPU 1 determines whether or not there is a master higher in memory access priority than the CPU 1. If there is such a master, the process proceeds to step S13, or otherwise proceeds to step S17. When being in the system operation state B, the process proceeds to step S13 because the DSPs 2 and 3 are higher in memory access priority than the CPU 1.

In step S13, the CPU 1 sets information indicating that issuance of a speculative access request is prohibited in the speculative control register 932 in the bridge 9. The bridge 9 therefore exerts control so as not to make issuance of a speculative access request for subsequent normal access from the CPU 1.

In step S14, the CPU 1 activates processing by the DSPs 2 and 3. This causes accesses to the memory 5 from the DSPs 2 and 3, and these accesses are arbitrated and processed by the memory controller 4.

In step S15, the CPU 1 detects whether or not processing by the DSPs 2 and 3 higher in priority than the CPU 1 has been terminated. If the processing has been terminated, the process proceeds to step S16, or otherwise returns to step S15.

In step S16, the CPU 1 sets information indicating that issuance of a speculative access request is permitted in the speculative control register 932. The bridge 9 therefore exerts control so as to make issuance of a speculative access request for subsequent normal access from the CPU 1. The process then returns to step S11.

In step S17, like step S16, the CPU 1 sets information indicating that issuance of a speculative access request is permitted in the speculative control register 932.

In step S18, the CPU 1 starts processing by the DSPs 2 and 3, and the process returns to step S11. This causes accesses to the memory 5 from the DSPs 2 and 3, and these accesses are arbitrated and processed by the memory controller 4.

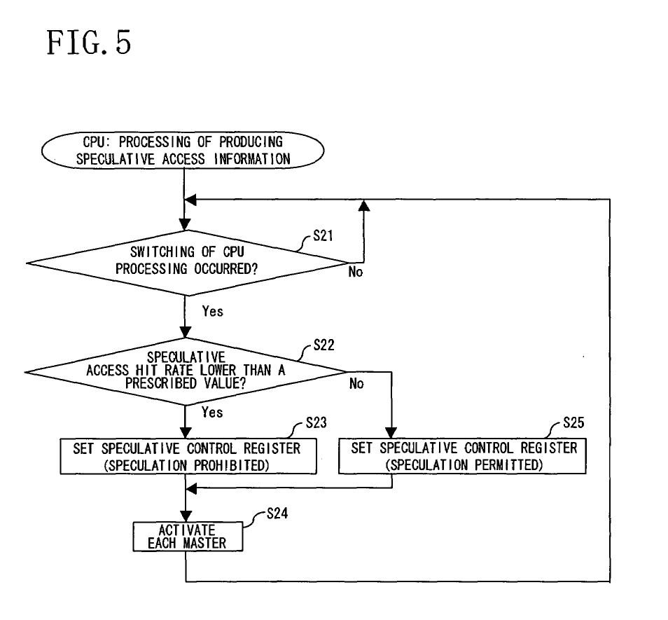

FIG. 5 is a flowchart showing another exemplary flow of processing by the CPU 1 in FIG. 1. In FIG. 5, the CPU 1 detects a time period during which the speculative access hit rate as speculative access information is high by software processing, and based on the detected result, controls issuance of a speculative access request by the bridge 9.

The speculative access hit rate as used herein refers to the ratio of the number of speculative access requests for which data transfer was found useful to the number of speculative access requests already issued for memory access arising from processing by the CPU 1, that is, the ratio of the number of data units that were actually used in subsequent normal access to the number of data units transferred to the buffer as a result of speculative access and held therein. An example of calculation of the speculative access hit rate is as follows. A plurality of processing items to be executed by the CPU 1 in a system are classified into some patterns in advance, and the CPU 1 calculates the speculative access hit rate by allowing the bridge to issue speculative access requests for each pattern in advance. In the subsequent actual operation, the CPU 1 detects to which CPU processing pattern the processing item belongs, to control issuance of a speculative access request. A speculative access request will be issued if the processing item belongs to a CPU processing pattern expected to give a speculative access hit rate equal to or higher than a predetermined value.

Assume herein that the processing by the CPU 1 switches from CPU processing A higher in speculative access hit rate to CPU processing B lower in speculative access hit rate, then to CPU processing C higher in speculative access hit rate sequentially.

In step S21, the CPU 1 detects whether or not switching of the CPU processing has occurred. If switching has occurred, the process proceeds to step S22, or otherwise returns to step S21.

In step S22, the CPU 1 determines whether or not the speculative access hit rate of the CPU processing is equal to or less than a predetermined value. If the speculative access hit rate is equal to or less than the predetermined value, the process proceeds to S23, or otherwise proceeds to step S25. For example, the process proceeds to step S23 if CPU processing B is executed, or proceeds to step S25 if CPU processing A or C is executed.

In step S23, the CPU 1 sets information indicating that issuance of a speculative access request is prohibited in the speculative control register 932 in the bridge 9. The bridge 9 therefore exerts control so as not to make issuance of a speculative access request for subsequent normal access from the CPU 1.

In step S24, the CPU 1 activates processing in the DSPs 2 and 3. This causes accesses to the memory 5 from the DSPs 2 and 3, and these accesses are arbitrated and processed by the memory controller 4. The process then returns to step S21.

In step S25, the CPU 1 sets information indicating that issuance of a speculative access request is permitted in the speculative control register 932. The bridge 9 therefore exerts control so as to make issuance of a speculative access request for subsequent normal access from the CPU 1.

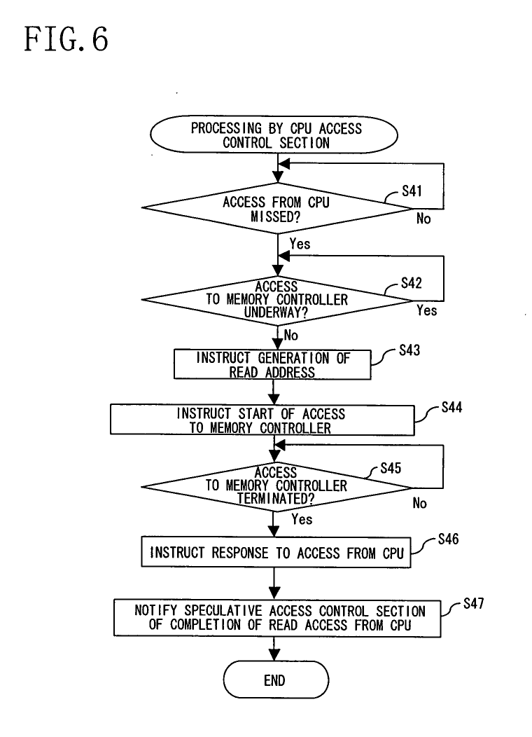

FIG. 6 is a flowchart showing an exemplary flow of processing by the CPU access control section 942 in FIG. 2. Herein, the case that there is a normal access from the CPU 1 will be described as an example.

In step S41 in FIG. 6, the CPU access control section 942 determines whether or not an access from the CPU 1 has missed (required data does not exist in the buffer memory 8). If date accessed from the CPU 1 does not exist in the buffer memory 8, the CPU access control section 942 is notified of this by the buffer read control section 911. The process then proceeds to step S42, or otherwise returns to step S41.

In step S42, the CPU access control section 942 detects whether or not access to the memory controller 4 is underway, that is, whether or not the memory controller interface 913 is under operation. If access is underway, the process returns to step S42. If not, the process proceeds to step S43. For example, if the memory controller interface 913 is under operation for a speculative access, the process waits for completion of the speculative access.

In step S43, the CPU access control section 942 controls the address generation section 916 and the memory read issuance section 917 to generate and output an address (read address) of data to be requested of the memory controller interface 913. In this address generation, the address generation section 916 refers to the address field of the access address register 931. The address generated is the address requested by the CPU 1.

In step S44, the CPU access control section 942 instructs the memory read issuance section 917 to allow the memory controller interface 913 to start access to the memory controller 4. The memory controller interface 913 sends a read request to the memory controller 4.

In step S45, the memory controller interface 913 receives read data from the memory controller 4 and outputs the data to the buffer write control section 912. The buffer write control section 912 writes the read data into the buffer memory 8. Once completing write of all read data into the buffer memory 8, the buffer write control section 912 notifies the CPU access control section 942 of completion of the write. The process then proceeds to step S46. In this step, the CPU access control section 942 updates the address field of the access address register 931 to the address outputted from the memory read issuance section 917, and also enables the valid bit. If write of all read data has not been terminated, the process returns to step S45.

In step S46, the CPU access control section 942 instructs the buffer read control section 911 to respond to the read request from the CPU 1. The buffer read control section 911 selects the read-requested data from data held in the buffer memory 8, and outputs the selected data to the CPU 1 via the CPU interface 910.

In step S47, the CPU access control section 942 notifies the speculative access control section 944 of completion of the read access (normal access) from the CPU 1. Note that no notification will be made in the case of using data held in the buffer memory 8.

Thereafter, as long as the subsequent read requests from the CPU 1 are for data held in the buffer memory 8, the requested data units are sequentially outputted from the buffer memory 8 to the CPU 1.

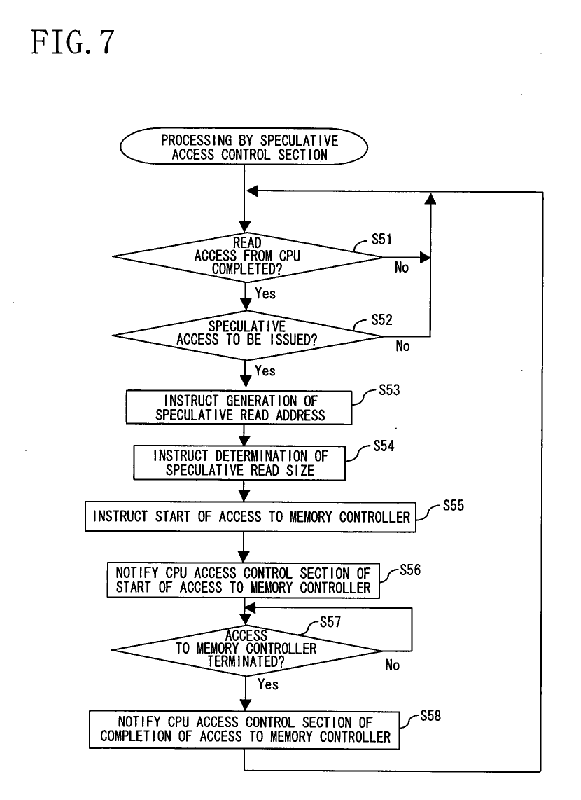

FIG. 7 is a flowchart showing an exemplary flow of processing by the speculative access control section 944. Assume herein that a memory access arising when data requested under normal access from the CPU 1 does not exist in the buffer memory 8 has been completed.

In step S51 in FIG. 7, the speculative access control section 944 waits for a notification of completion of the normal access from the CPU 1 by the CPU access control section 942. The process proceeds to step S52 if a completion notification is received, or otherwise returns to step S51.

In step S52, the speculative access control section 944 determines whether or not a speculative access request is to be issued based on information such as one in the register block 915. The process proceeds to step S53 if a speculative access request is to be issued, or otherwise returns to step S51.

In step S53, the speculative access control section 944 controls the address generation section 916 and the memory read issuance section 917 to generate and output an address (speculative read address) of data to be requested of the memory controller interface 913. In this address generation, the address generation section 916 adds a transfer size to the address in the address field of the access address register 931, to generate the speculative read address. In other words, the address generation section 916 generates an address consecutively following the address of data transferred last time from the memory according to a request from the CPU 1.

In step S54, the speculative access control section 944 controls the size determination section 920 and the memory read issuance section 917 to output the size of data to be requested of the memory controller interface 913. The size determination section 920 changes the size of data to be transferred to the buffer memory 8 in response to a speculative access request, with the speculative access hit rate and existence/absence of access requests from the DSPs 2 and 3 to the memory controller 4, for example.

In step S55, the speculative access control section 944 instructs the memory read issuance section 917 to allow the memory controller interface 913 to start access to the memory controller 4. The memory controller interface 913 sends a read request to the memory controller 4.

In step S56, the speculative access control section 944 notifies the CPU access control section 942 of start of a speculative access to the memory controller 4. The CPU access control section 942 will wait for completion of the speculative access if a need for normal access from the CPU 1 to the memory arises during the speculative access.

In step S57, the speculative access control section 944 determines whether or not the process by the memory controller 4 has been completed, that is, whether or not the access to the memory controller 4 has been terminated. The process proceeds to step S58 if the access has been terminated, or otherwise returns to step S57.

In step S58, the speculative access control section 944 notifies the CPU access control section 942 of completion of the access to the memory controller, and the process returns to step S51. Receiving this notification, the CPU access control section 942 is allowed to start processing of normal access from the CPU 1 to the memory 5 immediately if required to perform normal access.

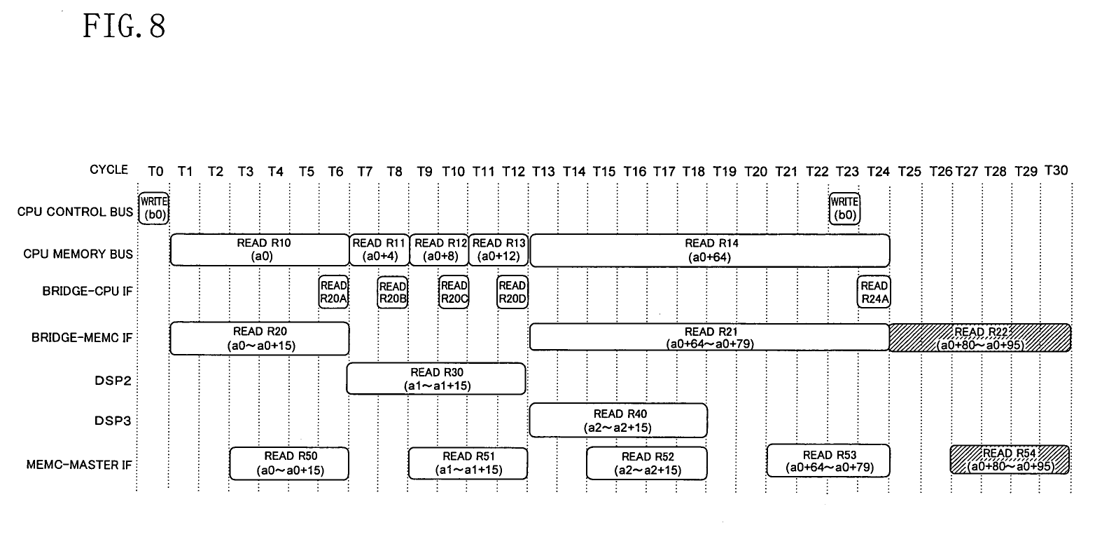

FIG. 8 is a timing chart showing a first example of operation of the unified memory system of FIG. 1. In FIG. 8, accessing in the CPU control bus 7, a CPU memory bus, interface (IF) between the bridge 9 and the CPU 1, interface between the bridge 9 and the memory controller (MEMC) 4 and interface between the memory controller 4 and a master is shown.

In FIG. 8, addresses a0, a1 and a2 are respectively the addresses of data of which read has been requested by the CPU 1 and DSPs 2 and 3. The range of data to be read or the address of the head of the range is shown inside the parentheses for each read. Hereinafter, the case that the CPU 1 operates according to the flowchart of FIG. 4 will be described with reference to FIGS. 4 and 8.

In cycle T0, the operation switches from the system operation state A (only the CPU 1 operates) to the system operation state B (the CPU 1 and the DSPs 2 and 3 operate). With this switching to the operation of the DSPs 2 and 3 higher in priority than the CPU 1, the CPU 1 sets prohibition of issuance of a speculative access request in the speculative control register 932 in the bridge 9 (step S13).

In cycle T1, the CPU 1 and the DSPs 2 and 3 start their processing. The DSP 2 issues an access request (read R30) to the memory 5 in and after cycle T7, and the DSP 3 issues an access request (read R40) to the memory 5 in and after cycle T13, but no speculative access request is issued from the CPU 1. A normal access from the CPU 1 and the accesses from the DSPs 2 and 3 are therefore arbitrated and processed by the memory controller 4.

In cycle T23, receiving notifications of completion of processing from the DSPs 2 and 3, the CPU 1 sets permission of issuance of a speculative access request in the speculative control register 932 in the bridge 9 via the CPU control bus 7 (step S16). Therefore, upon completion of the normal access in cycle T24, a speculative access request (read R22) is issued in cycle T25.

As described above, with the detection of existence of a master higher in priority and the setting of the speculative control register 932, the CPU 1 suppresses issuance of a speculative access request by the bridge 9. Thus, since the bridge 9 does not issue a speculative access request until completion of processing by a master higher in priority than the CPU 1, memory access can be completed within a predicted time without occurrence of having to wait for completion of speculative access. This prevents the performance of a master higher in priority than the CPU 1 from deteriorating.

Next, the case that the CPU 1 operates according to the flowchart of FIG. 5 will be described with reference to FIGS. 5 and 8.

In cycle T0, in switching from the CPU processing A (high in speculative access hit rate) to the CPU processing B (low in speculative access hit rate), the CPU 1 detects that the speculative access hit rate of the bridge 9 is low in the CPU processing B, and sets prohibition of issuance of a speculative access request in the speculative control register 932 in the bridge 9 via the CPU control bus 7 (step S23).

In cycle T1, the CPU 1 and DSPs 2 and 3 start their processing. The DSP 2 issues an access request (read R30) to the memory 5 in and after cycle T7, and the DSP 3 issues an access request (read R40) to the memory 5 in and after cycle T13, but no speculative access request is issued from the CPU 1. A normal access from the CPU 1 and the accesses from the DSPs 2 and 3 are therefore arbitrated and processed by the memory controller 4.

In cycle T23, in switching from the CPU processing B to the CPU processing C, the CPU 1 detects that the speculative access hit rate is high in the CPU processing C, and sets permission of issuance of a speculative access request in the speculative control register 932 in the bridge 9 via the CPU control bus 7 (step S25). With completion of the normal access in cycle T24, therefore, a speculative access request (read R22) is issued in cycle T25.

As described above, with the setting of the speculative control register 932, the CPU 1 suppresses issuance of a speculative access request by the bridge 9 when the speculative access hit rate is low. This prevents the performance of another master from deteriorating. Also, since the hit rate of actually issued speculative accesses increases, the processing performance of the CPU 1 can be improved.

The CPU 1 may detect the case that a memory access related to processing by the CPU 1 is to a cacheable region, that is, the case of a mishit, as being high in speculative access hit rate. This is based on the assumption that occurrence of a cache miss may result in subsequent consecutive cache misses.

The CPU 1 may use the priority of process ID assigned to each process in the processing by the CPU 1, to detect a memory access related to a process high in priority as being high in speculative access hit rate. The detection of a cache miss and the detection of process ID may be performed by software processing by the CPU 1, or by exclusive hardware provided in a cache interface or a memory management unit (MMU).

To follow the flowchart of FIG. 4 or 5 for control of speculative access, the CPU 1 must perform software processing for detecting switching of the system operation and setting the speculative control register 932, and this consumes the processing performance of the CPU 1. Also, in the control using the priorities of the masters as in FIG. 4, speculative access is uniformly controlled until completion of processing by a master high in priority. This results in that speculative access may be suppressed even when the master high in priority is not using the memory. In other words, this makes it difficult to perform speculative access control reflecting real time the memory access status. In view of this, another example of access operation will be described.

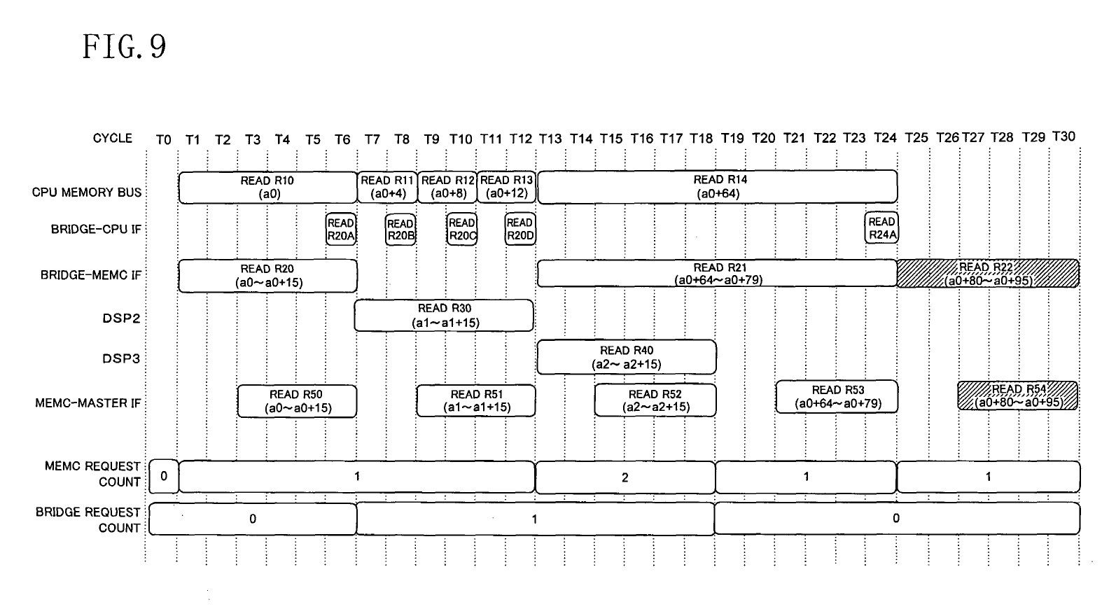

FIG. 9 is a timing chart showing a second example of operation of the unified memory system of FIG. 1. Hereinafter, described will be the case that the access information output section 409 of the memory controller 4 outputs the number of access requests from masters to the memory controller 4 (MEMC request count) as speculative access information, and the bridge 9 controls issuance of a speculative access request according to this speculative access information.

The CPU 1 sets in advance the condition for issuance of a speculative access request by the bridge 9 in the request count register 936 of the bridge 9. Assume herein that the CPU 1 sets in advance value “0” as the initial value of the request count register 936.

In the memory controller 4 receiving access requests from a plurality of masters, the access information output section 409 outputs the access request count to the request count register 936 to be stored therein. The speculative access control section 944 uses the output of the request count register 936 as the threshold in step S52 in FIG. 7. If the request count outputted from the access information output section 409 includes a request from the bridge 9, the speculative access control section 944 subtracts such a request from the request count and uses the subtracted count.

In cycle T6 in FIG. 9, the access request count will be “0” once a normal access from the CPU 1 is completed. Therefore, the speculative access control section 944 starts preparation for issuance of a speculative access request. In cycle T7, the DSP 2 issues an access request (read R30), and thus the access request count becomes “1”. With the access request count exceeding the threshold “0”, the bridge 9 does not issue a speculative access request but waits until the access request count becomes “0”.

Read R30 is completed in cycle T12. In cycle T13, the DSP 3 issues an access request (read R40) and the CPU 1 issues a normal access request (read R21). With the access request count exceeding the threshold “0”, the bridge 9 does not issue a speculative access request but waits until the access request count becomes “0”. Read R40 is completed in cycle T18, and thus the access request count is “1” in cycle T19.

The access request count will be “0” once read R21 is completed. In cycle T24, therefore, the speculative access control section 944 starts preparation for issuance of a speculative access request. In cycle T25, in which the access request count becomes “0”, the speculative access control section 944 issues a speculative access request to start speculative access (read R22).

Note that the address accessed during speculative access, the transfer size and the like are determined based on read R21 as the immediately preceding normal access, not based on read R20.

In the operation shown in FIG. 9, issuance of a speculative access request can be controlled in an individual cycle in which a chance for issuing a speculative access request occurs, not being controlled by the CPU 1. The CPU 1 therefore executes the speculative access control only when the condition for issuance of a speculative access request is changed, and thus the CPU processing performance can be less consumed. Also, because issuance of a speculative access request is suppressed real time, the system performance can be prevented from deteriorating even in the case of having a number of requests.

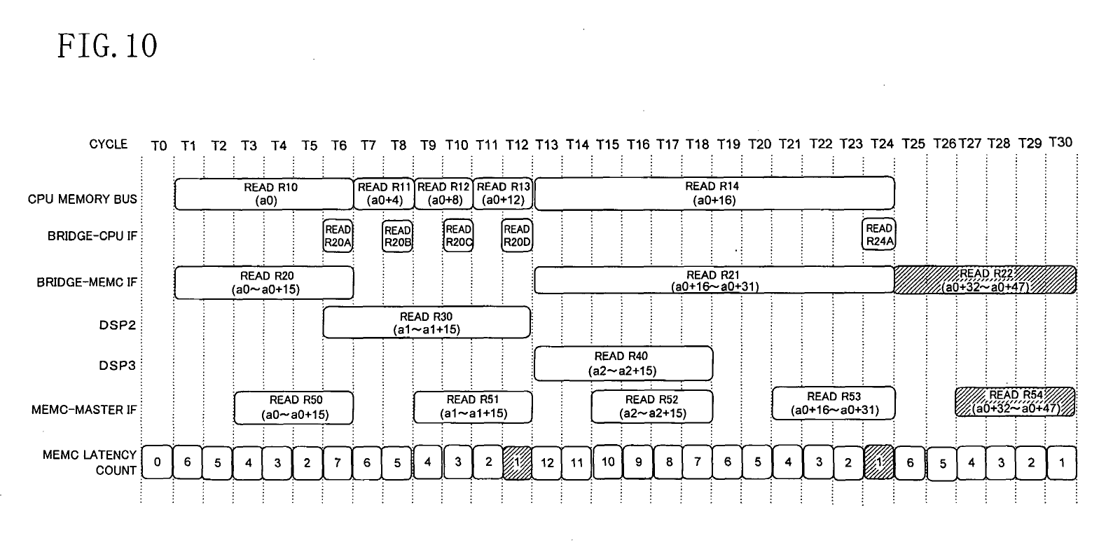

FIG. 10 is a timing chart showing a third example of operation of the unified memory system of FIG. 1. Hereinafter, described will be the case that the access information output section 409 of the memory controller 4 outputs the latency count (MEMC latency count) as speculative access information, and the bridge 9 controls issuance of a speculative access request according to this information.

The CPU 1 sets in advance the condition for issuance of a speculative access request by the bridge 9 in the latency register 937 of the bridge 9. Assume herein that the CPU 1 sets in advance value “1” in the latency register 937.

The access information output section 409 calculates the latency count for a new request from the number of waiting access requests and the remaining number of cycles in the current memory access, and outputs the result to the latency register 937 to be stored therein. The speculative access control section 944 uses the output of the latency register 937 as the threshold in step S52 in FIG. 7.

In cycle T6 in FIG. 10, the speculative access control section 944 determines whether or not a speculative access request is to be issued upon completion of a normal access from the CPU 1. The DSP 2 issues an access request (read R30) in cycle T6, and the access information output section 409 outputs the latency count “7” as speculative access information to the bridge 9. With the latency count exceeding the threshold “1”, the bridge 9 does not issue a speculative access request.

In cycle T12, in which read R30 will be completed reducing the latency count to “1”, the speculative access control section 944 starts preparation for a speculative access request.

In cycle T13, the DSP 3 issues an access request (read R40) and the CPU 1 issues an access request (read R21). This raises the latency count to “12”. With the latency count exceeding the threshold “1”, no speculative access request is issued.

In cycle T24, in which read R21 will be completed reducing the latency count to “1”, the speculative access control section 944 starts preparation for a speculative access request.

In cycle T25, the latency count becomes “0”. The speculative access control section 944 therefore issues a speculative access request to start speculative access.

In the case of FIG. 10, also, the address accessed during the speculative access, the transfer size and the like are determined based on read R21 as the immediately preceding normal access, not based on read R20.

In the operation shown in FIG. 10, the CPU 1 executes the speculative access control only when the condition for issuance of a speculative access request is changed, and thus the CPU processing performance can be less consumed. Also, because issuance of a speculative access request is suppressed in an individual cycle in which a chance for issuing a speculative access request arises, the system performance can be prevented from deteriorating even in the case of having a large latency count. Issuance of a speculative access request is also suppressed even when the CPU 1 issues a normal access, and thus the access performance of the CPU 1 can be improved.

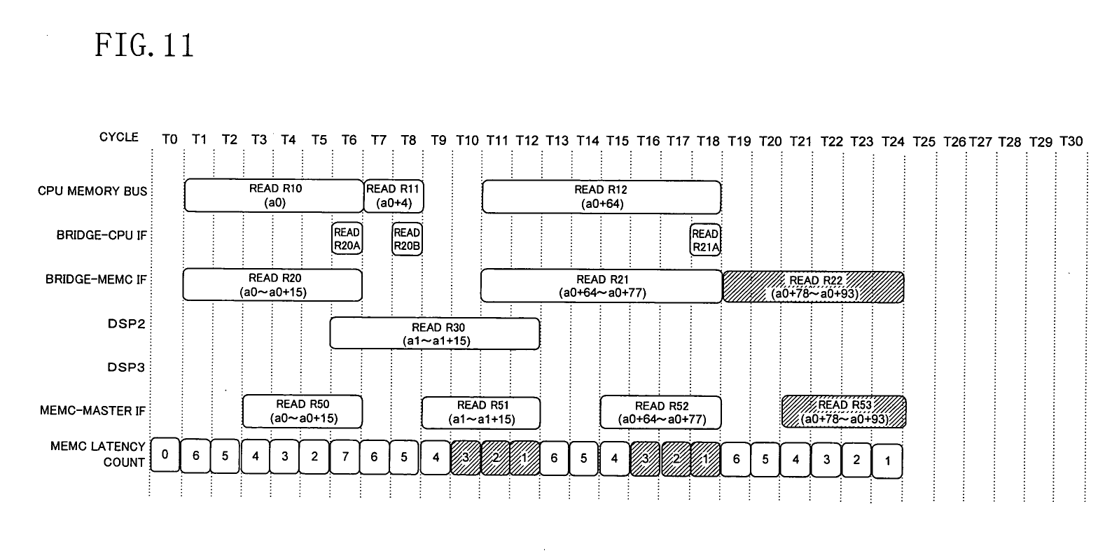

FIG. 11 is a timing chart showing a fourth example of operation of the unified memory system of FIG. 1. As in the case of FIG. 10, described hereinafter will be the case that the bridge 9 receives the latency count (MEMC latency count) as speculative access information from the access information output section 409 of the memory controller 4, and controls issuance of a speculative access request according to this information. In this case, however, assume that value “3” is set in the latency register 937. The speculative access control section 944 uses the output of the latency register 937 as the threshold in step S52 in FIG. 7.

In cycle T6 in FIG. 11, as in the case of FIG. 10, the access information output section 409 outputs “7” as access information to the bridge 9. With the latency count exceeding the threshold “3”, the bridge 9 does not issue a speculative access request.

In cycle T10, with the progress of the memory access corresponding to read R30, the latency count decreases to “3” that agrees with the threshold “3”. The speculative access control section 944 therefore starts preparation for a speculative access request.

In cycle T11, the CPU 1 issues an access request (read R12) to the bridge 9. If the requested data in read R12 does not exist in the buffer memory 8, a normal access request (read R21) is to be issued. In this case, the speculative access control section 944 does not issue a speculative access request until completion of read R21.

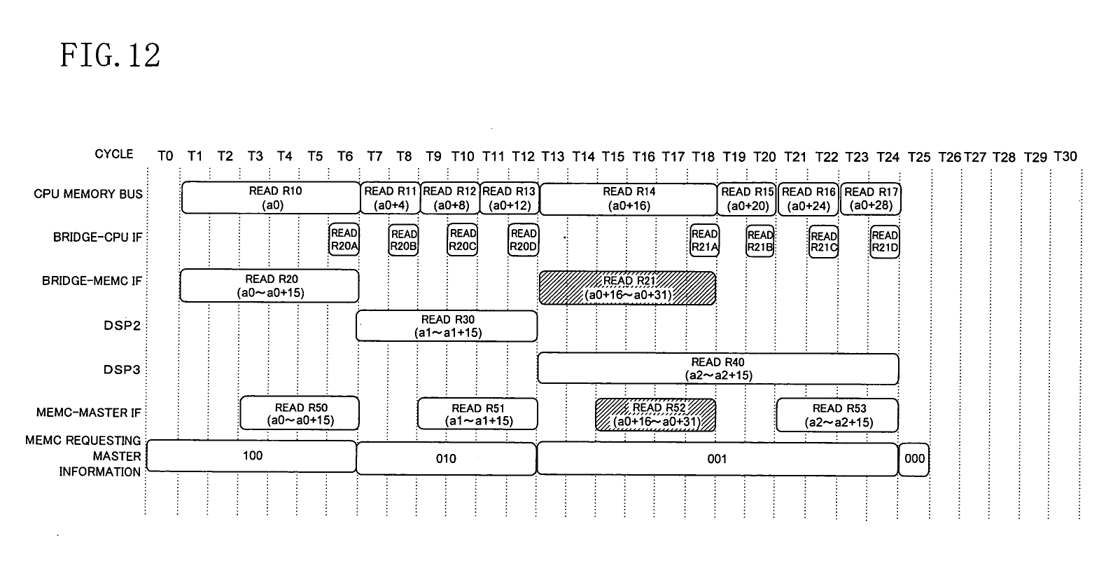

FIG. 12 is a timing chart showing a fifth example of operation of the unified memory system of FIG. 1. Hereinafter described will be the case that the access information output section 409 of the memory controller 4 outputs requesting master information (MEMC requesting master information) as speculative access information, and the bridge 9 controls issuance of a speculative access request according to this information.

The requesting master information is information indicating a master currently under issuance of an access request to the memory controller 4, in which each of the bits of the requesting master information is assigned to each master, for example. Assume that the value of the bit corresponding to a given master is “1” if the master is under issuance of an access request and “0” if it is not.

For example, the requesting master information may be made of bits assigned to the CPU 1, the DSP 2 and the DSP 3 in this order. In this case, the information will be encoded to “010” if only the DSP 2, among the CPU 1, the DSP 2 and the DSP 3, is under issuance of an access request, or to “001” if only the DSP 3 is under issuance of an access request. The access information output section 409 outputs the requesting master information indicating the master that is under issuance of an access request to the bridge 9.

The CPU 1 sets in advance the priority of an access request from another master with respect to a speculative access request, as a condition for issuance of a speculative access request by the bridge 9, in the requesting master information register 938 of the bridge 9. Each bit of the requesting master information register 938 is assigned to each master. Assume that the value of the bit assigned to a given master is “1” if the priority of an access request from the master is higher and “0” if it is not.

The requesting master information register 938 has bits assigned to the CPU 1, the DSP 2 and the DSP 3 in the same order as the requesting master information. As an example, assume herein that out of the DSPs 2 and 3, the DSP 2 is a master higher in priority over the CPU 1, that is, the CPU 1 sets “010” in the requesting master information register 938. The speculative access control section 944 uses the output of the requesting master information register 938 and the requesting master information in step S52 in FIG. 7.

In cycle T6 in FIG. 12, the speculative access control section 944 determines whether or not a speculative access request is to be issued upon completion of a normal access from the CPU 1. The access information output section 409 outputs requesting master information “100” as speculative access information to the bridge 9. With no access request receiving from the DSP 2 higher in priority, the bridge 9 starts preparation for issuance of a speculative access request.

In cycle T7, the DSP 2 issues an access request (read R30), and thus the requesting master information changes to “010”. Being found that the master (DSP 2) specified by the requesting master information register 938 has issued an access request, priority is given to read R30, and no speculative access request is issued until completion of read R30.

In cycle T13, while read R30 has been completed, the DSP 3 issues an access request (read R40). The requesting master information then becomes “001”. Since the DSP 3 is not a master specified by the requesting master information register 938, the speculative access control section 944 issues a speculative access request (read R21). The access from the DSP 3 must wait for completion of read R21.

In the operation shown in FIG. 12, issuance of a speculative access request can be controlled in an individual cycle in which a chance for issuing a speculative access request arises, not being controlled by the CPU 1. The CPU 1 therefore can reduce its processing related to speculative access control. Also, issuance of a speculative access request is suppressed if memory access arises from a master higher in priority than memory access from the CPU 1. The system performance can therefore be prevented from deteriorating.

As an alteration, both the system operation status and the memory access status may be used for speculative access control, as will be described below.

Assume that a plurality of speculative control-related registers used for speculative access control are provided as in the register block 915 in FIG. 2 and that a corresponding speculative control parameter is stored in each register. The speculative control parameter is speculative access information or a value for controlling issuance of a speculative access determined based on the speculative access information.

The CPU 1 detects switching of the system operation state, selects a speculative control parameter to be used and its corresponding register according to the system operation state, and sets the selected results in the parameter selection register 933. The combination of the system operation state and the speculative control-related register may be determined in advance, or may be determined by extracting the system state. In this way, issuance of a speculative access request can be controlled with an appropriate speculative control-related register.

The speculative access control section 944 may perform weighted calculation of determination results on issuance of a speculative access request obtained based on a plurality of selected speculative control parameters, using a value of the weight setting register 934, to execute speculative access control according to the calculation result.

An example of the above speculative access control will be described using the speculative access hit rate outputted from the CPU 1 and the latency count outputted from the memory controller 4 as the speculative control parameters.

The bits of the parameter selection register 933 are assigned to the speculative control-related registers. For example, assume that the bits of the parameter selection register 933 are assigned to the speculative control register 932, the request count register 936, the latency register 937 and the requesting master information register 938 in descending order from the most significant bit, and that “1010” are set in the parameter selection register 933. This indicates that the speculative control register 932 and the latency register 937 are set as the speculative control-related registers to be used.

The CPU 1 sets a value in the speculative control register 932 according to the speculative access hit rate. The memory controller 4 calculates the access latency and outputs the result to the bridge 9.

In the weight setting register 934, a coefficient for weighting the determination results on issuance of a speculative access request based on the speculative control-related registers is set. For example, assuming that the determination result based on the speculative control register 932 is considered in the proportion of 40% while the determination result based on the latency register 937 is considered in the proportion of 60%, “4600” will be set in the weight setting register 934. Upon completion of a normal access from the CPU 1, the bridge 9 will control issuance of a speculative access request in the following steps.

In the first step, the speculative access control section 944 makes determination on issuance of a speculative access request based on the selected speculative control parameters. For each of the speculative control parameters, “1” will be given as the determination result if it is determined that a speculative access request should be issued, and “0” will be given if it is determined that a speculative access request should not be issued.

Assume that the CPU 1 sets “1” in the speculative control register 932 judging that a speculative access request should be issued because the speculative access hit rate is higher than a predetermined value. Assume also that the CPU 1 sets “2” in the latency register 937, and that the memory controller 4 outputs “3” as the latency count. In this case, the speculative access control section 944 gives “1” for the speculative access hit rate, and gives “0” for the latency count because the latency count is larger than the value of the latency register 937, as the determination results.

In the second step, the speculative access control section 944 performs weighted calculation of the determination results for the plurality of speculative control parameters using the value of the weight setting register 934. The result of the weighted calculation is (0×6+1×4)/2=2, which is used as a control value for controlling speculative access.

In the third step, the speculative access control section 944 issues a speculative access request only when the control value for speculative access exceeds a threshold. For example, assuming that the threshold is “3”, the speculative access control section 944 does not issue a speculative access request. Specifically, the speculative access control section 944 suppresses issuance of a speculative access request as long as being notified of a large latency count by the memory controller 4 even if the CPU 1 determines that the speculative access hit rate is high.

If the latency count outputted from the memory controller 4 is small enough to give a determination result of “1” for the latency count, the result of the weighted calculation will be (1×6+1×4)/2=5. In this case, the speculative access control section 944 issues a speculative access request.

As described above, the speculative access control using both the system operation status and the memory access stratus can suppress the possibility that the system performance may greatly deteriorate.

In place of actual weighted calculation of a plurality of speculative control parameters, the speculative access control value may be obtained using the speculative control pattern table storage section 919. The speculative control pattern table storage section 919 stores therein a speculative control pattern table as a lookup table. The speculative control pattern table is configured so that the input address is a value indicating a combination of a plurality of speculative control parameters and the output data is a result of weighted calculation (weighted calculation value) of determination results on issuance of a speculative access request obtained for the respective speculative control parameters.

The speculative access control section 944 enters a combination of a plurality of speculative control parameters into the speculative control pattern table storage section 919, and receives a weighted calculation value as the speculative access control value. This eliminates the necessity of the parameter selection register 933, the weight setting register 934 and an operator for weighted calculation.

Different values may be set in the speculative control pattern table depending on the value of a speculative control parameter. For example, assume that the speculative access hit rate and the latency count are selected as the speculative control parameters. The weight on the determination result for the speculative access hit rate is decreased if the latency count is small and increased if it is large, and the weighted calculation values are calculated in advance for the respective cases. This permits optimum setting for control of issuance of a speculative access request.

If the memory access priority of the CPU 1 is high and the hit rate of speculative access by the bridge 9 is high (that is, a high speculative access hit rate is predicted), the bridge 9 may be allowed to issue a speculative access, not only after completion of a normal access from the CPU 1, but also after completion of a speculative access. That is, the bridge 9 may be allowed to issue speculative accesses consecutively. If the above prediction is made, the CPU 1 may set the speculative multiple control register 935 so as to indicate permission of consecutive issuance of speculative accesses. The CPU 1 and the speculative access control section 944 then set the speculative control register 932 according to the setting of the speculative multiple control register 935.

With the configuration described above, the speculative access hit rate will be further increased when the speculative access hit rate is high enough to allow memory access over continuous regions, and this can further improve the processing performance of the CPU 1.

The hit rate of speculative access by the bridge 9 may be measured by the bridge 9 itself. The bridge 9 manages data held in the buffer memory 8 by differentiating data resulting from normal access from the CPU 1 from data resulting from speculative access by the bridge 9. If data resulting from speculative access is used by normal access, the speculative access hit rate is determined high. The speculative access hit rate measured by the bridge 9 may be used in combination with the speculative access hit rate predicted by the CPU 1. This will further increase the speculative access hit rate, and can further improve the processing performance of the CPU 1.

Consecutive issuance of speculative accesses may be made according to the access request count from the memory controller 4 and information on a master under accessing.

The size determination section 920 may change the size of data to be requested of the memory controller 4, according to the system operation status and the memory access status, so that data transferred in response to a speculative access request or a subsequent consecutively-issued speculative access request has a size corresponding to speculative access information (speculative access hit rate, access request count from the memory controller 4, information on a master under accessing and the like).

The above size change configuration is advantageous for the case that the memory access priority of the CPU 1 is high, the hit rate of speculative access by the bridge 9 is high and no access from other masters to the memory controller 4 is underway. The size of data to be requested may be increased to up to the capacity of the buffer memory 8 as the upper limit, to increase the data pre-read amount. This will further increase the speculative access hit rate, and can further improve the processing performance of the CPU 1.

Although the bridge 9 is provided with the speculative access control section 944 in the above embodiment, the memory controller 4 may be provided with the speculative access control section 944. For example, the bridge 9 and the buffer memory 8 may be incorporated in the memory controller 4.

A specific master may be selected from a plurality of masters, to allow speculative access control for the selected master. For example, in a system in which a plurality of CPUs are connected as masters and the priorities of the CPUs vary with time, the CPU high in priority may be selected to allow speculative access control for the selected CPU. This can improve the processing performance of each CPU. With this configuration, the hardware scale can be reduced compared with the case of having a bridge and a buffer memory for each CPU.

As described above, according to the present invention, the system performance is prevented from deteriorating due to speculative access from the CPU. The present invention is therefore useful as a unified memory system and further applicable to a system LSI and the like adopting unified memory architecture.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A unified memory system comprising:
a memory accessed from a plurality of masters;
a speculative access control section for issuing, in response to a first access request to the memory from a CPU as one of the plurality of masters, a speculative second access request to the memory; and
a memory controller for receiving the first and second access requests and an access request to the memory from any of the plurality of masters other than the CPU and executing access to the memory,
wherein the speculative access control section issues the second access request according to speculative access information as information related to access to the memory.

2. The system of claim 1, wherein the CPU controls the speculative access control section using the speculative access information.

3. The system of claim 2, wherein the CPU uses memory access priorities of the plurality of masters as the speculative access information, and
the speculative access control section issues the second access request if the memory access priority of the CPU is higher than the memory access priority of any of the plurality of masters other than the CPU.

4. The system of claim 2, wherein the CPU determines a hit rate indicating the proportion in which data transfers already executed in response to speculative access requests were useful, as the speculative access information, and
the speculative access control section issues the second access request if the hit rate is higher than a predetermined value.

5. The system of claim 1, wherein the memory controller produces the speculative access information.

6. The system of claim 5, wherein the memory controller outputs the number of access requests from the plurality of masters as the speculative access information, and
the speculative access control section issues the second access request if the number of access requests is smaller than a predetermined value.

7. The system of claim 5, wherein the memory controller outputs the number of cycles required for completion of access to the memory as the speculative access information, and
the speculative access control section issues the second access request if no unexecuted normal access to the memory exists and the number of cycles is smaller than a predetermined value.

8. The system of claim 5, wherein the memory controller outputs requesting master information indicating a master that is under issuance of an access request to the memory, among the plurality of masters, as the speculative access information, and
the speculative access control section issues the second access request if the requesting master information does not indicate a predetermined master.

9. The system of claim 1, wherein the speculative access control section issues the second access request according to a parameter selected from a plurality of parameters as the speculative access information.

10. The system of claim 9, wherein the speculative access control section issues the second access request according to the result of weighted calculation of determination results on issuance of a second access request obtained based on a plurality of parameters selected.

11. The system of claim 1, further comprising a size determination section for setting the size of data to be transferred in response to the second access request at a value corresponding to the speculative access information.

12. The system of claim 1, wherein the speculative access control section issues a speculative third access request for accessing the memory after completion of access to the memory according to the second access request if the priority of access to the memory from the CPU is high.

13. The system of claim 12, further comprising a size determination section for setting the size of data to be transferred in response to the third access request at a value corresponding to the speculative access information.

14. The system of claim 12, wherein the speculative access control section determines a hit rate indicating the proportion in which data transfers already executed in response to speculative access requests were useful, and issues the third access request if the hit rate is higher than a predetermined value.

15. The system of claim 14, further comprising a size determination section for setting the size of data to be transferred in response to the third access request at a value corresponding to the hit rate.
